(19) United States
(12) Patent Application Publication
(10) Pub. No.: US 2007/0137392 A1
(43) Pub. Date: Jun. 21, 2007

(54) Intermittent linear movement control device

(76) Inventor: Chau-Tsung Chen, Sinjhuang City (TW)

Correspondence Address: LOWE HAUPTMAN BERNER, LLP, 1700 DIAGONAL ROAD, SUITE 300, ALEXANDRIA, VA, 22314, US

(21) Appl. No.: 11/284,027

(22) Filed: Nov. 22, 2005

(51) Int. Cl. F16C 1/10

(52) U.S. Cl. 74/502.4

(57) ABSTRACT

An intermittent linear movement control device includes: movement elements flexibly connected to one another and each having a sliding groove at a lower surface thereof; each sliding groove has an upper portion thereof as an arcuate sliding groove and two sides thereof as gap-like dissected half-length sliding grooves, with the dissected half-length sliding grooves in communication with the arcuate sliding groove, and the dissected half-length sliding grooves of respective movement elements joined with each other for forming a full-length sliding groove; and a small pulley flexibly connected in one of the sliding grooves and capable of performing eccentric rotations by forces received; wherein, the plurality of movement elements horizontally and linearly moves forward when the small pulley moves in the full-length sliding grooves, and remains at halt when the small pulley moves in idle in the arcuate sliding grooves.

### BACKGROUND OF THE INVENTION

(a) Field of the Invention

The invention is related to an intermittent linear movement control device, and more particularly, to a control device for accurately, intermittently and horizontally moving in circulation a plurality of objects-to-be processed.

(b) Description of the Prior Art

According to U.S. Pat. No. 6,615,690 and U.S. Pat. No. 6,892,608 of the inventor, an active small pulley is adopted for relative movements in a sliding groove to drive a circular upper disc for performing intermittent halt and rotating an arched distance. However, the prior inventions are capable of merely providing the upper disc with intermittent rotations using a center line thereof as a center of rotation but not circulated intermittent linear and horizontal movements. As a result, a number of work stations defined by the upper disc is limited. It is a vital task of the invention as how to control the work stations for intermittent horizontal movement.

### SUMMARY OF THE INVENTION

The primary object of the invention is to provide an intermittent linear movement control device having upper plate bodies capable of circulated intermittent movements, thereby increasing a number of working stations defined by the upper plate bodies.

### BRIEF DESCRIPTION OF THE DRAWINGS

FIG. 1 shows a partial elevational view illustrating a connecting portion of the movement element and a transmission mechanism according to the invention.

FIG. 2 shows another partial elevational view illustrating a connecting portion of the movement element and a transmission mechanism according to the invention.

FIG. 3 shows a schematic view illustrating motions of the movement element in halt according to the invention.

FIG. 4 shows a schematic view illustrating motions of the movement element moving linearly forward according to the invention.

FIG. 5 shows an exploded elevational view of the movement element and the outer plate body according to the invention.

FIG. 6 shows another exploded elevational view of the movement element and the outer plate body according to the invention.

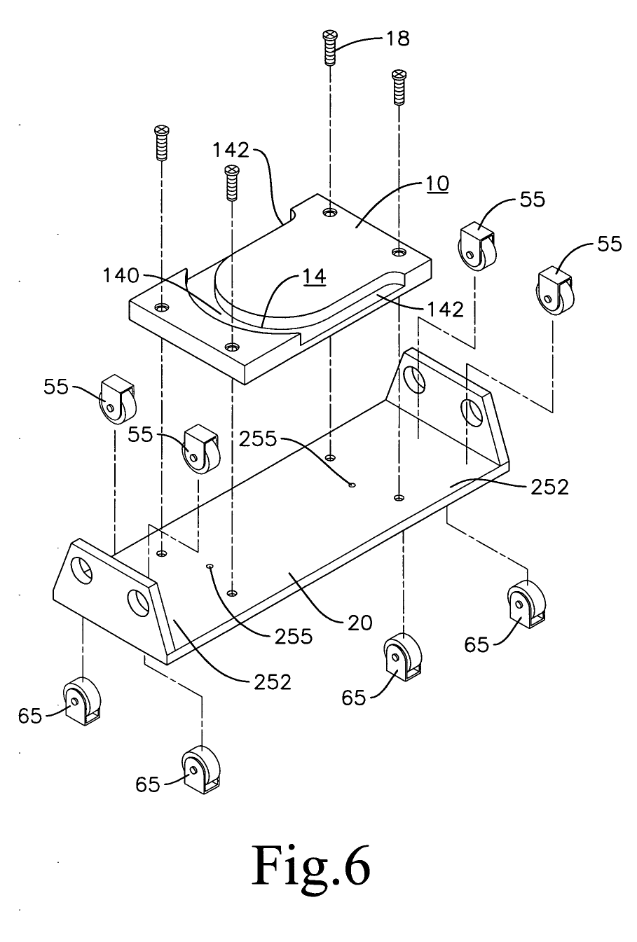

FIG. 7 shows a longitudinal sectional view according to the invention.

FIG. 8 shows a schematic view illustrating motions of the movement element of another embodiment according to the invention.

FIG. 9 shows a schematic view illustrating motions of the movement element of yet another embodiment according to the invention.

FIG. 10 shows an exploded elevational view of the movement element and the outer plate body of another embodiment according to the invention.

FIG. 11 shows a longitudinal sectional view in another embodiment according to the invention.

FIG. 12 shows an enlarged partial sectional view of the small pulleys flexibly connected to the sliding groove according to the invention.

FIG. 13 shows an elevational view illustrating the invention in coordination with a housing.

FIG. 14 shows a sectional view of cone-shaped small pulleys flexibly connected to a cone-shaped sliding groove.

FIG. 15 shows a sectional view of cone-shaped small pulleys flexibly connected to a V-shaped sliding groove.

FIG. 16 shows an exploded elevational view of the movement element and the outer plate body in another embodiment according to the invention.

FIG. 17 shows a schematic view illustrating motions of the movement element according to the invention.

FIG. 18 shows another schematic view illustrating motions of the movement element according to the invention.

### DETAILED DESCRIPTION OF THE PREFERRED EMBODIMENTS

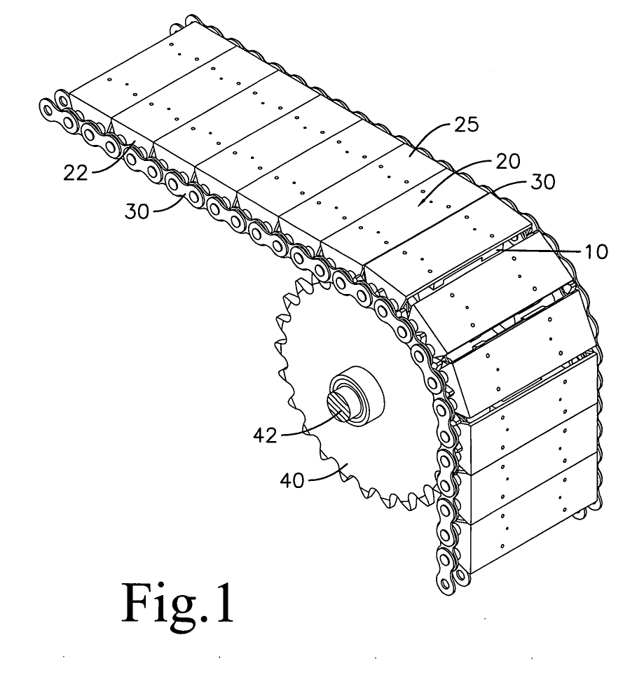

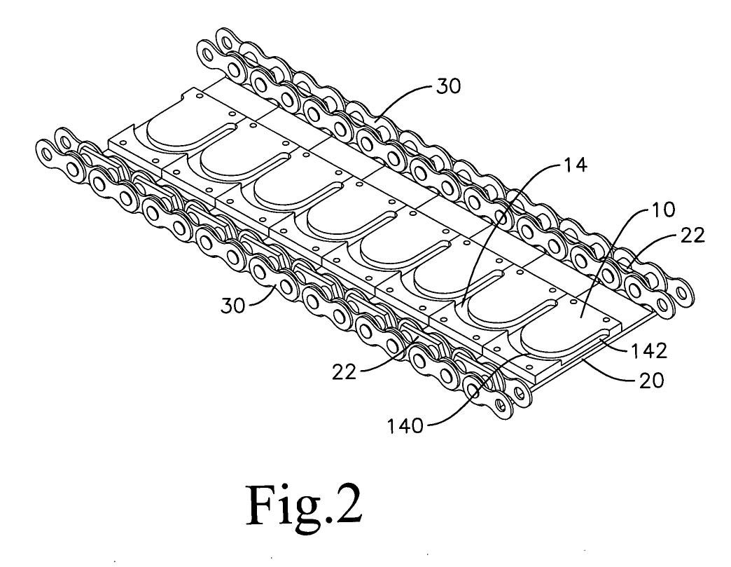

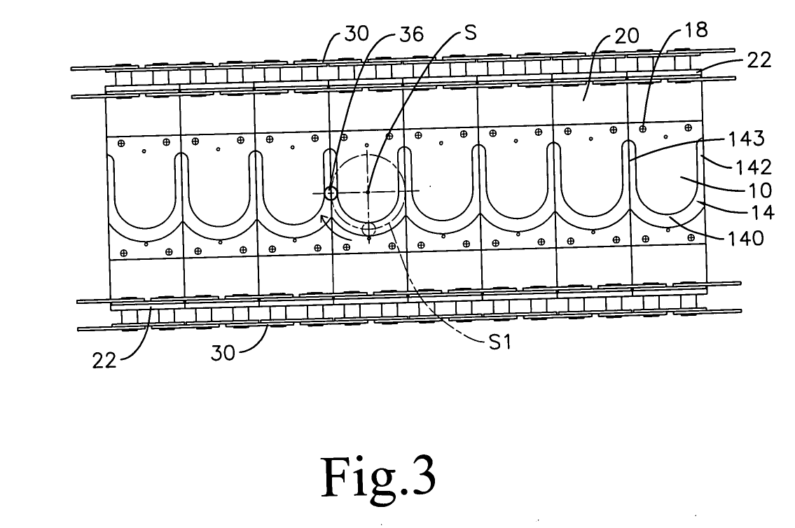

Referring to FIG. 1, FIG. 2 and FIG. 3, an intermittent linear movement control device according to the invention comprises:
a plurality of movement elements 10 flexibly connected to one another and controlled for intermittent horizontal movement, and each having a sliding groove 14 at a lower surface thereof; wherein each sliding groove 14 has an upper portion thereof as an arcuate sliding groove 140, two sides thereof as gap-like dissected half-length sliding grooves 142, with the dissected half-length sliding grooves 142 in communication with the arcuate sliding groove 140, and dissected half-length sliding grooves 142 and (142) of respective movement elements 10 and (10) joined with each other for forming a full-length sliding groove 143; and
a small pulley 36 flexibly connected in the sliding groove and capable of performing eccentric rotations by forces received; wherein the plurality of movement elements 10 horizontally and linearly move forward when the small pulley 36 moves in the full-length sliding grooves 143, and remain at halt when the small pulley 36 moves in idle in the arcuate sliding groove 140.

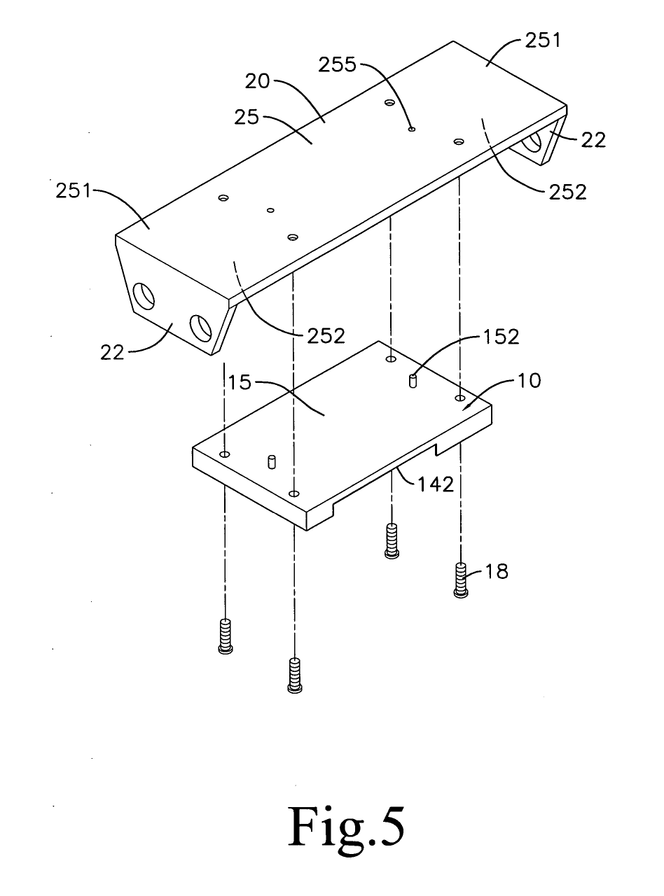

According to the aforesaid primary characteristics with reference to FIG. 1 and FIG. 5, each movement element 10 has an upper surface 14 thereof fixed to an outer plate body 20, which has a connecting section 22 at both sides thereof respectively for connecting to a chain 30; and a plurality of gears 40 individually engaged at the chain 30, such that the chain 30 is allowed with circulated movement and the plurality of outer plate bodies 20 are allowed with circulated horizontal movement by the chain 30.

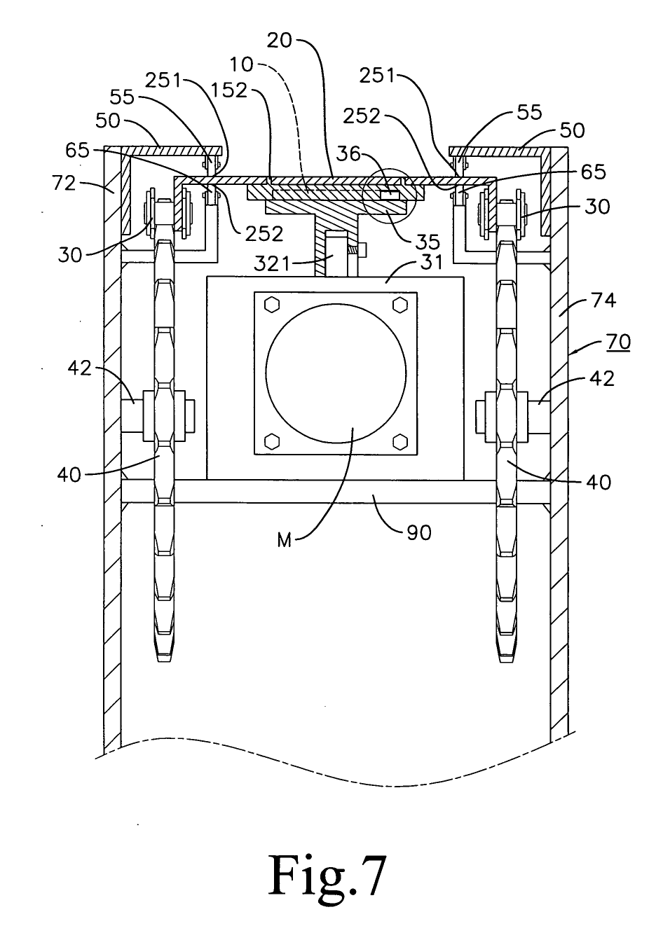

According to the aforesaid primary characteristics with reference to FIG. 7, the small pulley 36 is located at a side of a surface of a turning disc 35. The turning disc 35 is connected with a rotation axis 321 driven by a transmission case 31, which has transmission elements therein driven by a motor M.

According to the aforesaid primary and secondary characteristics and with reference to FIG. 7, each outer plate body 20 has an upper side of each of two sides thereof mounted by an upper locating member 50 and a lower side of each of two sides thereof devised with a lower locating member 60. As shown in FIG. 5, each upper locating member 50 has a lower end surface thereof connected with a bearing 55 for pressing against a side upper surface 251 of the outer plate body 20, and each lower locating member 60 has an upper end surface thereof connected with a bearing 65 for pressing against a side lower surface 252 of the outer plate body 20.

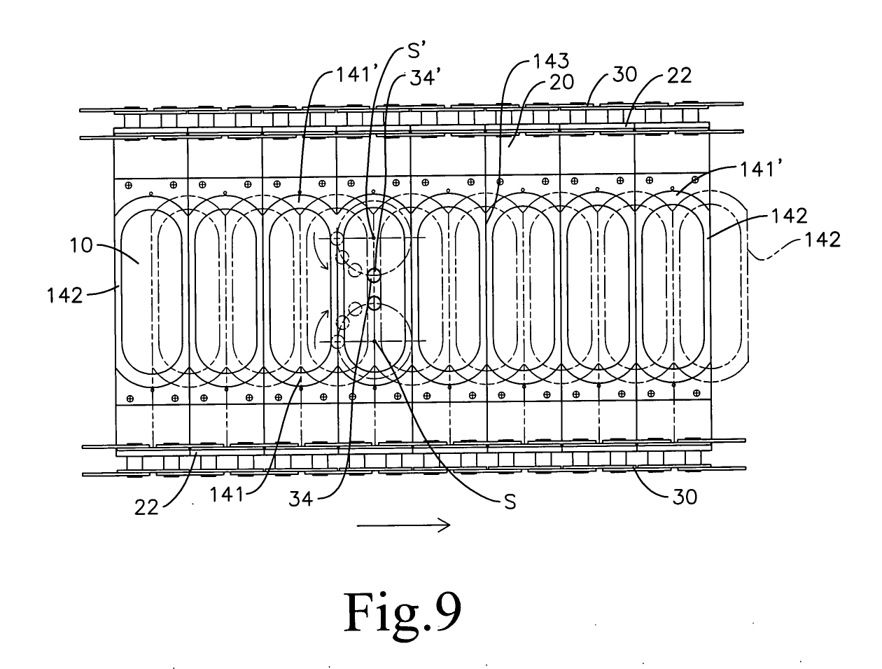

According to the aforesaid primary and secondary characteristics and with reference to FIG. 7 and FIG. 9, two sets of chains 30 have sides thereof respectively provided with a left wall body 72 and a right wall body 74 to form a housing 70; and the upper locating members 50, the lower locating members 60 and a central locating axis of the gear 40 are fixed to the left and right wall bodies 72 and 74.

According to the aforesaid primary and secondary characteristics and with reference to FIG. 5, each movement element 10 is fastened to the outer plate body 20 using screw bolts 18, and the upper surface 15 of the movement element 10 has a projecting pin 152 for inserting into an insertion opening 255 provided at the outer plate body 20.

According to the aforesaid primary and secondary characteristics and with reference to FIG. 9, the outer plate bodies 20 connected to the movement elements 10 are accommodated and fixed with objects to-be-processed 80 that move in linear along with the movement elements 10.

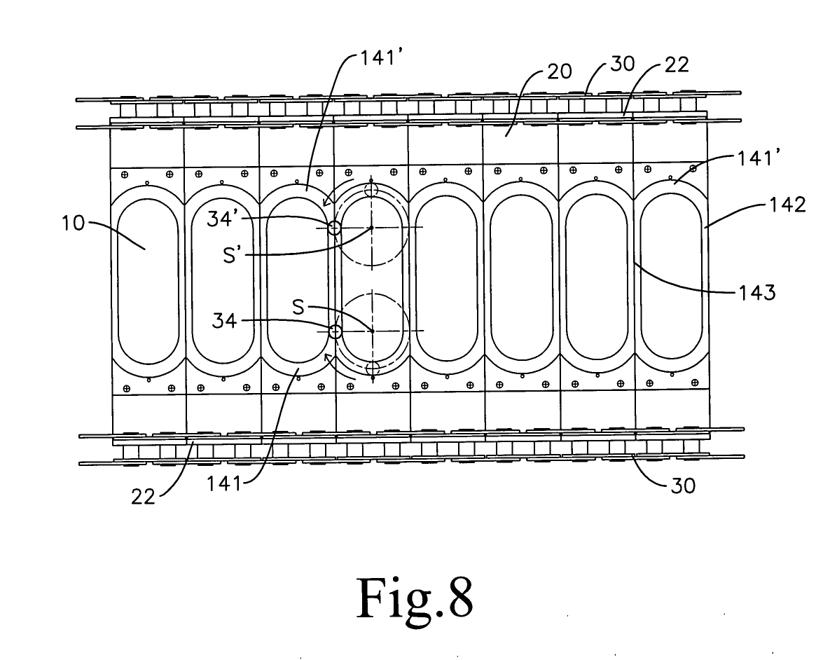

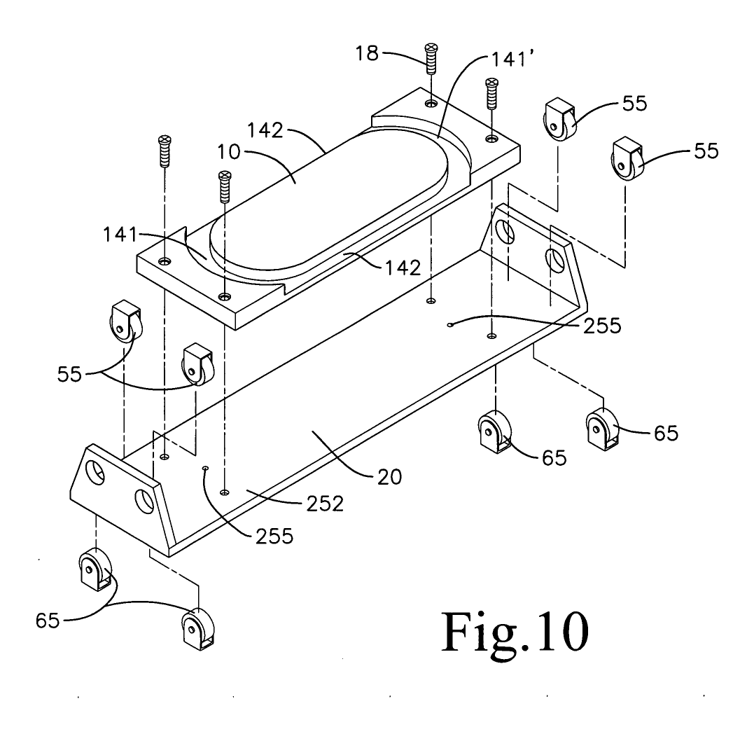

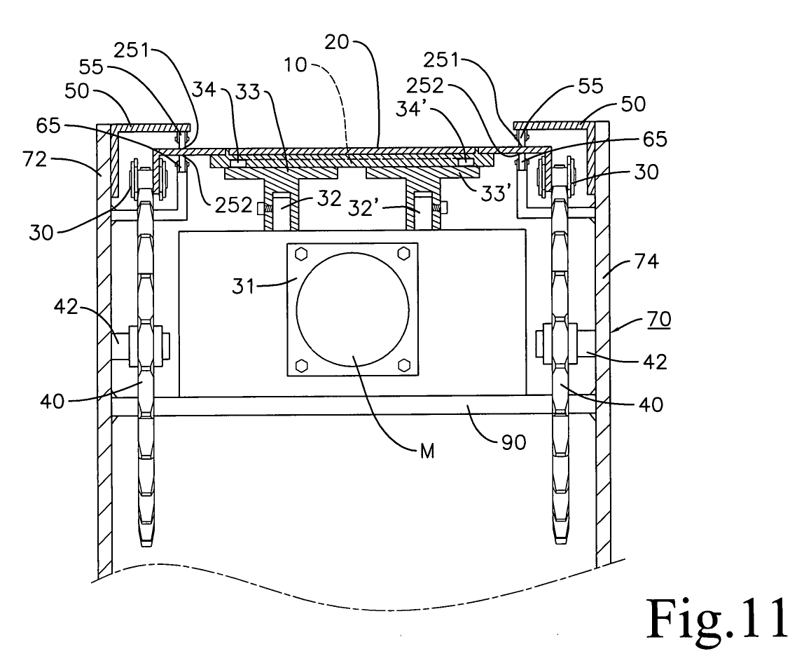

Referring to FIG. 8, FIG. 9, FIG. 10 and FIG. 11, an intermittent linear movement control device according to the invention comprises:
a plurality of movement elements 10 flexibly connected to one another and controlled for intermittent horizontal movement, and each having corresponding first arcuate sliding groove 141 and second arcuate sliding groove 141′, and two sides thereof as gap-like dissected half-length sliding grooves 142 and (142); wherein, the two dissected half-length sliding grooves 142 and (142) are respectively in communication with the first and second arcuate sliding grooves 141 and 141′, and the dissected half-length sliding grooves 142 and (142) of respective movement elements 10 and (10) are joined with each other for forming a full-length sliding groove 143; and
a first small pulley 34 and a second small pulley 34′ flexibly connected in the first arcuate sliding groove 141 and the second arcuate sliding groove 141′ respectively; wherein, the plurality of movement elements 10 horizontally and linearly move forward when the first and second small pulleys 34 and 34′ simultaneously move in the full-length sliding grooves 143, and remain at halt when the first and second small pulleys 34 and 34′ move in idle in the first and second arcuate sliding grooves 141 and 141′.

According to the primary characteristics and with reference to FIG. 11, the first small pulley 34 is located at a side of a surface of a first turning disc 33; and the first turning disc 33 is connected with a first rotation axis 32 driven by a transmission case 31, which has transmission elements therein driven by a motor M;
the second small pulley 34′ is located at a side of a surface of a second turning disc 33′; and the second turning disc 33′ is connected with a second rotation axis 32′ driven by a transmission case 31′, which has transmission elements therein driven by a motor M; and
the first and second rotation axes 32 and 32′ are simultaneously rotated.

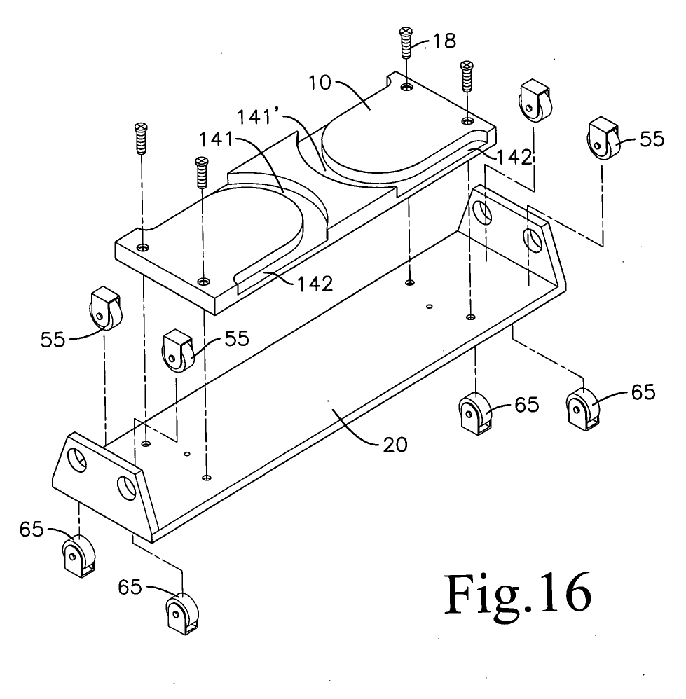

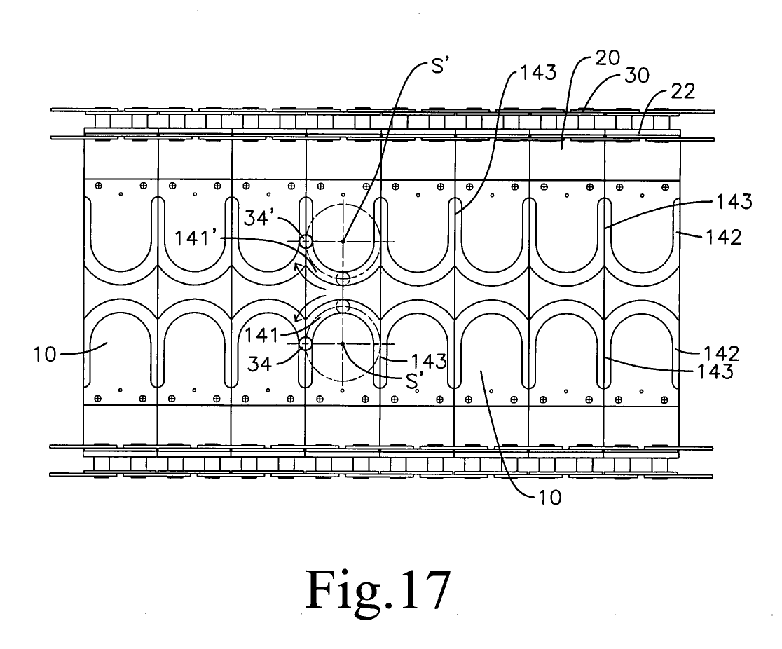

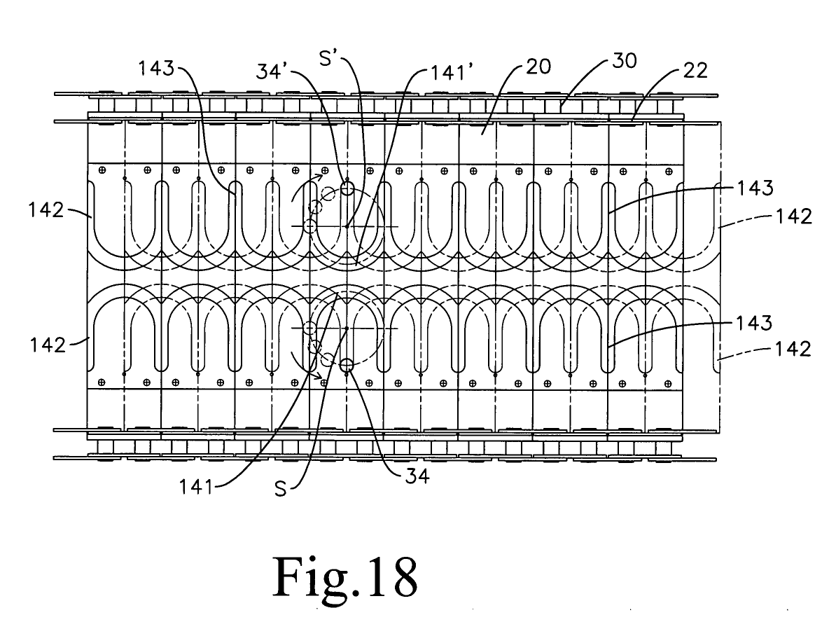

Referring to FIG. 16, FIG. 17 and FIG. 18, the first and second arcuate sliding grooves 141 and 141′ can be devised near a center of the movement elements 10, such that the first and second arcuate sliding grooves 141 and 141′ are adjacent to each other.

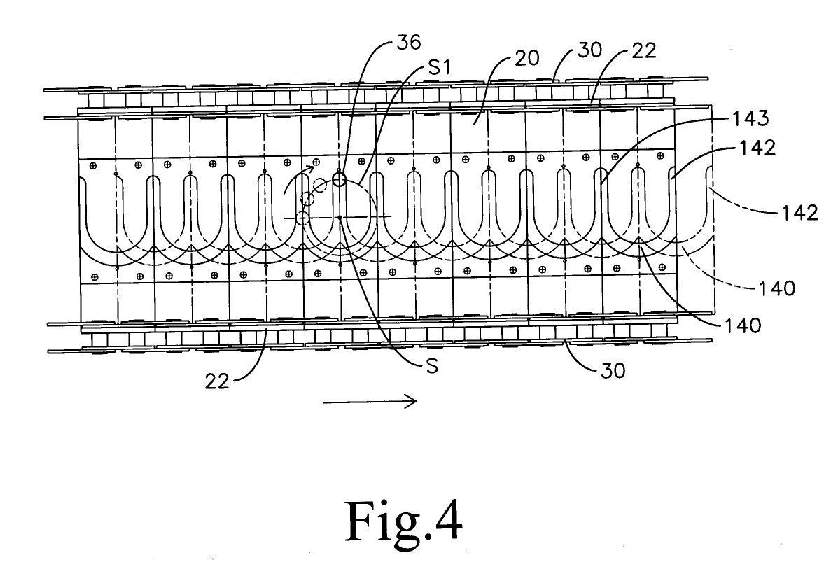

Referring to FIG. 7, when the motor M is activated, power is transmitted to the transmission case 31 that changes a rotational speed of the motor M to a low gear, such that the rotational axis 321 is rotated by power output from the transmission case 31. The rotation axis 321 simultaneously drives the turning disc 35 for rotations, and the small pulley 36 attached to the turning disc 35 performs eccentric rotations along a circular line S1 relative to an axis center line S of the rotation axis 32 as shown in FIG. 4.

When moving in the full-length sliding groove 143, the small pulley 36 acts upon an inner wall of the full-length sliding groove 143, and thus each movement element 10 linearly moves with a certain distance. Referring to FIG. 3, when the small pulley 36 moves into the arcuate sliding groove 140, the small pulley 36 is regarded as idle as moving along the circular line S1 instead of acting upon the inner wall of the arcuate sliding groove 140. At this point, the movement elements 10 are at halt. Referring to FIG. 4, when the small pulley 36 is slid into an adjacent full-length sliding groove 143, each movement element 10 linearly moves with a certain distance as described above. Referring to FIG. 1, a plurality of gears 40 is respectively engaged at front and rear ends of the chains 30 and (30), and is driven by the chains 30 and (30) to rotate relative to a rotation axis 42. The chains 30 and (30) have sides thereof connected to the connecting sections 22 of the outer plate body 20 connected to the movement elements 10. When being driven forward by the small pulley 36, the movement elements 10 also drive the outer plate body 20 and the two chains 30 and (30) to simultaneously, linearly and intermittently move forward with a certain distance, thereby allowing the outer plate body 20 with linear movement in circulation.

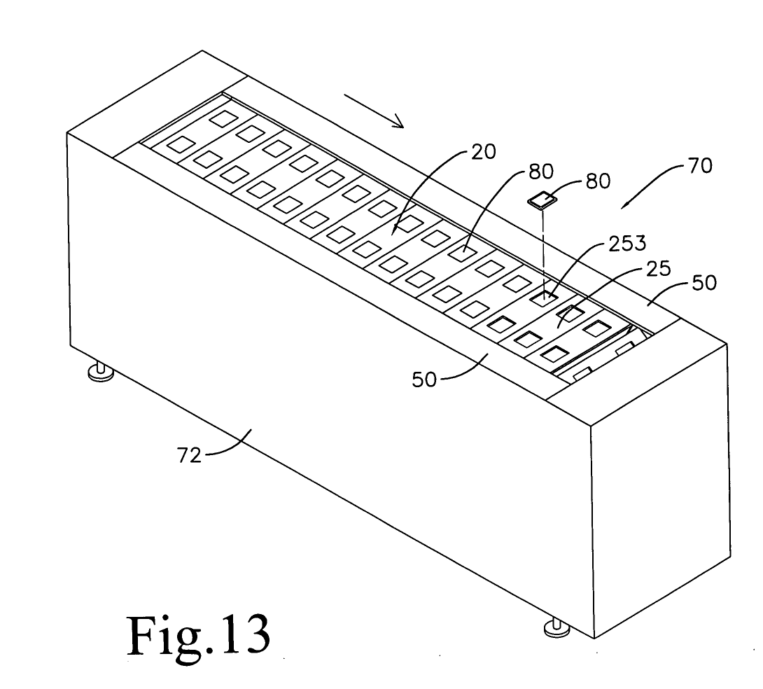

Referring to FIG. 13, each outer plate body 20 has an upper surface thereof provided with a recess 253 or a smelting apparatus for accommodating or positioning objects to-be-processed 80 (or filling). During linear movement, each of the objects to-be-processed 80 passing through is processed (welding or filling for instance) by a processing apparatus (not shown) above a machine housing 70 using intermittent downward actions. When forwarded to an end section of horizontal movement, the objects to-be-processed 80 are picked up by other apparatuses after having been processed. The outer plate bodies 20 are linearly moved in a downward direction along a portion where the gears 40 are flexibly connected, and keep performing circulated movement. When the chains 30 pass through the gears 40, connecting edges of each two adjacent outer plate bodies 20 and (20) are separated as shown in FIG. 1. Similarly, a same portion of the full-length sliding groove 143 of the movement element 10 is separated into two half-length sliding grooves 142 and (142). When the outer plate bodies 20 and the movement element 10 perform simultaneous linear movements, the two adjacent outer plate bodies 20 and (20) appear as a planar shape, the adjacent movement elements 10 also appear as a planar shape, and the two dissected half-length sliding grooves 142 and (142) are joined to form a full-length sliding groove 143 as shown in FIG. 3 and FIG. 4.

As shown in FIG. 7, the upper locating member 50 is consisted of an angle steel at left and right sides thereof, respectively, wherein each angle steel is connected with at least one bearing 55 that is in contact with a side upper surface 251. The lower locating member 60 is consisted of L-shaped angle steels connected with at least one bearing 65. Each bearing 65 is in contact and pressed against the side lower surface 252, and is for stabilizing horizontal movement of the outer plate bodies 20, which provide stabilizing effects during linear horizontal movement thereof. Thus, each outer plate body 20 is provided with maximized horizontal status, such that two adjacent dissected half-length sliding grooves 142 and (142) are combined to form a structure having a surface without unevenness.

The motor M and the transmission case 31 are located to a crossbeam 90 having two ends thereof located to left and right walls 72 and 74.

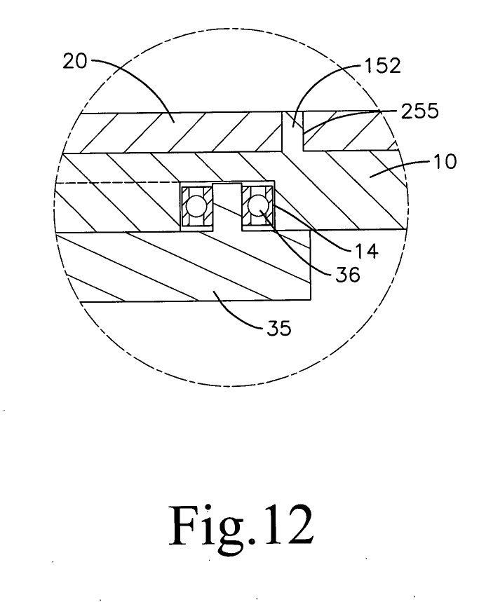

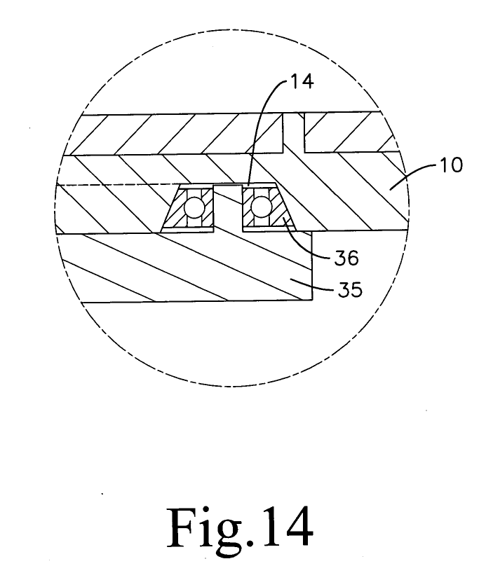

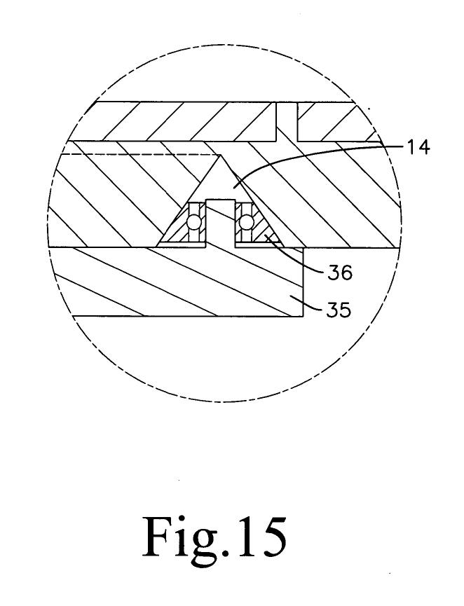

Referring to FIG. 5, the outer plate body 20 is fastened to the movement element 10 by means of screw bolts 18. Using the projecting pins 152, the outer plate body 20 is tightly joined with the movement element 10. Therefore, when the movement 10 moves, the outer plate body 20 is accurately impelled and moved at the same time. Referring to FIG. 12, the small pulleys 36 are common column-shaped bearings. FIG. 14 shows another embodiment of the small pulleys 36 coordinating with the sliding grooves 14. Inner walls of the sliding grooves 14 are devised at cone-shaped, and bearings defined by the small pulleys 36 are cone-shaped as well. Referring to FIG. 15, the sliding grooves 14 may be V-shaped, and the coordinating small pulleys 36 are cone-shaped. In addition, the chains 30 according to the invention can be replaced by other interlocking assemblies such as belts and gears, and the gears 40 can be replaced by belts.

Referring to FIG. 8, FIG. 9 and FIG. 10 showing another embodiment according to the invention, each movement element 10 is provided with first and second arcuate sliding grooves 141 and 141′ for accommodating a first small pulley 34 and a second small pulley 34′. Rotational speeds and movement angles of the first and small pulleys 34 and 34′ are the same, and therefore the first and second small pulleys 34 and 34′ rotate along circular lines along the two axis center lines S and S′, respectively. When the first and second small pulleys 34 and 34′ move at the same time to act in the full-length sliding groove 143, an inner wall of the full-length sliding groove 143 is provided with impelling forces for driving the movement elements 10 and (10) with a certain distance. When the first and second small pulleys 34 and 34′ are simultaneously located in the first and second arcuate sliding grooves 141 and 141′, the first and second small pulleys 34 and 34′ are considered as rotating in idle with arcuate movement, and the movement elements 10 and 10′ are at a halt. In this embodiment, the first and second small pulleys 34 and 34′ serve as impellers of the movement elements 10 and (10) to increase stability of the movement elements 10 and (10) during movement process while also elevating force-withstanding strength of the movement elements 10 and (10).

Referring to FIG. 16, FIG. 17 and FIG. 19, the first and second arcuate sliding grooves 141 and 141′ can also be reverse designs. The first and second arcuate sliding grooves 141 and 141′ are adjacent with a short adjacent distance. Due to common axis lines S and S′ of the first and second arcuate sliding grooves 141 and 141′ as shown in FIG. 17, technical principles of actions and movements of the first and second small pulleys 34 and 34′ in the full-length sliding groove 143 are the same as in the first and second arcuate sliding grooves 141 and 141′ shown in FIG. 8, FIG. 9 and FIG. 10.

Conclusive from the above, the invention is capable of accurately controlling intermittent horizontal and linear movement of the outer plate bodies 20 for accomplishing circulated movement.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. An intermittent linear movement control device comprising:
a plurality of movement elements flexibly connected to one another and controlled for intermittent horizontal movement, and each having a sliding groove at a lower surface thereof; wherein, each sliding groove has an upper portion thereof as an arcuate sliding groove and two sides thereof as gap-like dissected half-length sliding grooves, with the dissected half-length sliding grooves in communication with the arcuate sliding groove, and the dissected half-length sliding grooves of respective movement elements joined with each other for forming a full-length sliding groove; and
a small pulley flexibly connected in one of the sliding grooves and capable of performing eccentric rotations by forces received; wherein, the plurality of movement elements horizontally and linearly moves forward when the small pulley moves in the full-length sliding grooves, and remains at halt when the small pulley moves in idle in the arcuate sliding grooves.

2. The intermittent linear movement control device in accordance with claim 1, wherein each movement element has an upper surface thereof fixed to an outer plate body, which has a connecting section at both sides thereof respectively for connecting to a chain; and
a plurality of gears individually engaged at the chain, such that the chain is allowed with circulated movement and the plurality of outer plate bodies are allowed with circulated horizontal movement by the chain.

3. The intermittent linear movement control device in accordance with claim 1, wherein the small pulley is located at a side of a surface of a turning disc, and the turning disc is connected with a rotation axis driven by a transmission case, which has transmission elements therein driven by a motor.

4. The intermittent linear movement control device in accordance with claim 1 or 2, each outer plate body has an upper side of each of two sides thereof mounted by an upper locating member and a lower side of each of two sides thereof devised with a lower locating member, each upper locating member has a lower end surface thereof connected with a bearing for pressing against a side upper surface of the outer plate body, and each lower locating member has an upper end surface thereof connected with a bearing for pressing against a side lower surface of the outer plate body.

5. The intermittent linear movement control device in accordance with claim 1 or 2 or 4, wherein two sets of chains have sides thereof respectively provided with a left wall body and a right wall body to form a housing; and the upper locating members, the lower locating members and a central locating axis of the gear are fixed to the left and right wall bodies.

6. The intermittent linear movement control device in accordance with claim 1 or 2, wherein each movement element is screwed to the outer plate body using screw bolts, and the upper surface of the movement element has a projecting pin for inserting into an insertion opening provided at the outer plate body.

7. The intermittent linear movement control device in accordance with claim 1 or 2, wherein the outer plate bodies connected to the movement elements are accommodated and fixed with objects to-be-processed that move in linear along with the movement elements.

8. An intermittent linear movement control device comprising:
a plurality of movement elements flexibly connected to one another and controlled for intermittent horizontal movement; and each having corresponding first arcuate sliding groove and second arcuate sliding groove, and two sides thereof as gap-like dissected half-length sliding grooves; wherein, the two dissected half-length sliding grooves are respectively in communication with the first and second arcuate sliding grooves, and dissected half-length sliding grooves of respective movement elements are joined with each other for forming a full-length sliding groove; and
a first small pulley and a second small pulley flexibly connected in the first arcuate sliding groove and the second arcuate sliding groove respectively; wherein, the plurality of movement elements horizontally and linearly moves forward when the first and second small pulleys simultaneously move in the full-length sliding grooves, and remains at halt when the first and second small pulleys move in idle in the first and second arcuate sliding grooves.

9. The intermittent linear movement control device in accordance with claim 8, wherein:
the first small pulley is located at a side of a surface of a first turning disc, and the first turning disc is connected with a first rotation axis driven by a transmission case, which has transmission elements therein driven by a motor;
the second small pulley is located at a side of a surface of a second turning disc, and the second turning disc is connected with a second rotation axis driven by a transmission case, which has transmission elements therein driven by a motor; and
the first and second rotation axes are simultaneously rotated.

10. The intermittent linear movement control device in accordance with claim 8, wherein the first and second arcuate sliding grooves are devised near a center of the movement elements, such that the first and second arcuate sliding grooves are adjacent to each other.
